(19) United States
(12) Patent Application Publication
(10) Pub. No.: US 2023/0339300 A1
(43) Pub. Date: Oct. 26, 2023

(54) BACK DOOR STRUCTURE OF VEHICLE

(71) Applicant: Mazda Motor Corporation, Hiroshima (JP)

(72) Inventors: Masaki MATSUSHITA, Aki-gun (JP); Kohei Fukumitsu, Aki-gun (JP); Atsushi Ito, Aki-gun (JP); Takayuki Sugishima, Aki-gun (JP)

(73) Assignee: Mazda Motor Corporation, Hiroshima (JP)

(21) Appl. No.: 18/126,703

(22) Filed: Mar. 27, 2023

(30) Foreign Application Priority Data
Apr. 25, 2022 (JP) 2022-071565

(51) Int. Cl. B60J 5/10

(52) U.S. Cl. CPC B60J 5/107

(57) ABSTRACT

A back door structure of a vehicle capable of reducing noise in a vehicle interior by suppressing vibration of an outer panel while reducing the weight and costs includes an outer panel and an inner panel. The inner panel includes a horizontal frame part, side-direction frame parts, and connecting parts. The horizontal frame part and each of the side-direction frame parts are mutually connected. The connecting part extends only from one end part on an opening part side in a vertical width direction of the horizontal frame part, the connecting part extends only from one end part on an opening part side in the vertical width direction of the side-direction frame part, and the connecting part extends only from one end part on an opening part side in the vertical width direction of the side-direction frame part. The connecting parts are respectively connected to the outer panel.

### CROSS-REFERENCE TO RELATED APPLICATION

The present application claims priority to Japanese Patent Application 2022-071565, filed Apr. 25, 2022, the entire contents of which are incorporated herein by reference.

### BACKGROUND

### Field

The present disclosure relates to a back door structure of a vehicle.

### Description of the Related Art

In vehicles such as vans including a SUV (Sport Utility Vehicle), an opening part is provided on the rear of a vehicle body, and a back door for opening and closing the opening part is attached. The height and width of the back door increase with increase in size of the vehicle.

Incidentally, suppression of vibration is required for the back door during traveling of the vehicle. This is because occurrence of vibration in a panel of the back door during traveling of the vehicle causes generation of noise in a vehicle interior. The structure for suppressing vibration of the panel of the back door during traveling of the vehicle is disclosed in Patent Document 1.

In a back door structure disclosed in Patent Document 1, the back door is formed by connecting an outer panel to an inner panel. The inner panel is provided with an opening part at a lower half placed lower than a windshield opening part, and is provided with an intermediate side part, lower part side parts, and a lower side part so as to surround the periphery of the opening part. Then, three joining parts are extended from a lower side of the intermediate side part in the inner panel, and one joining part is extended from each of the right-and-left lower part side parts. These joining parts are connected to the outer panel. Moreover, a reinforcing member for reinforcing an opening part for a latch is mounted at the lower side part, and the inner panel and the outer panel are fixed also by the reinforcing member.

In Patent Document 1, the inner panel and the outer panel are connected by five joining parts and one reinforcing member to thereby suppress vibration of the back door during traveling of the vehicle.

### PATENT DOCUMENTS

[Patent document 1] JP-A-2011-148464

### SUMMARY

### Problems to be Solved

The reduction in weight and in cost are required in vehicles, and the reduction in weight and in cost of the back door also has problems. As countermeasures for reducing the weight and reducing costs of the back door, it is considered that a frame part of the inner panel is reduced in width, that the above-described reinforcing member is removed, and the like.

However, as a result of study by inventors of the present application, it is found that, in the back door structure disclosed in the above Patent Document 1, there arises a problem that torsion occurs at the frame part of the inner panel around an axial center of the frame part extending in a longitudinal direction due to vibration inputted from the outer panel in the case where the frame part (the intermediate side part, the lower side part, and the like) of the inner panel is reduced in width and the reinforcing member is removed. When the above torsion occurs at the frame part of the inner panel, it is difficult to suppress film surface resonance of the outer panel, and so-called booming noise may occur in the vehicle interior.

It can be considered that the width of the frame part is widened and that the frame part is connected to the outer panel on both sides in a width direction to suppress the torsion at the frame part of the inner panel; however, these are contrary to the reduction in weight and in cost of the back door.

The present disclosure has been made for solving the above problems, and an object thereof is to provide a back door structure of a vehicle capable of reducing noise in the vehicle interior by suppressing vibration of the outer panel while reducing the weight and costs.

### Solutions for Solving the Problems

A back door structure of a vehicle according to an aspect of the present disclosure is a back door structure of a vehicle including a windshield opening part to which a windshield is fitted, which has an outer panel, an inner panel, and a plurality of connecting parts. The outer panel is a panel forming an outer side of the vehicle in the back door. The inner panel is a panel for forming an inner side of the vehicle in the back door. The plurality of connecting parts connect the outer panel and the inner panel.

The inner panel according to the aspect includes a first opening part, a second opening part, a third opening part, a fourth opening part, a first side-direction frame part, a second side-direction frame part, and a horizontal frame part. The first opening part is an opening part provided above a lower end side of the inner panel in a lower position than the windshield opening part. The second opening part is an opening part provided between the first opening part and the windshield opening part. The third opening part is an opening part provided between the first opening part/the second opening part and a right end side of the inner panel. The fourth opening part is an opening part provided between the first opening part/the second opening part and a left end side of the inner panel. The first side-direction frame part is a frame part extending between the second opening part and the third opening part in an up and down direction and provided to be inclined so as to gradually come close to the side of the right end side as going from a lower end to an upper end. The second side-direction frame part is a frame part extending between the second opening part and the fourth opening part in the up and down direction and provided to be inclined so as to gradually come close to the side of the left end side as going from a lower end to an upper end. The horizontal frame part is a frame part extending between the first opening part and the second opening part in a right and left direction and provided so that a right end is connected to the lower end of the first side-direction frame part and a left side is connected to the lower end of the second side-direction frame part.

In this aspect, the plurality of connecting parts include a first connecting part, a second connecting part, and a third connecting part. The first connecting part connects only one end part in a vertical width direction of the horizontal frame part to the outer panel. The second connecting part connects only one end part in the vertical width direction of the first side-direction frame part to the outer panel. The third connecting part connects only one end part in the vertical width direction of the second side-direction frame part to the outer panel.

In the back door structure of the vehicle according to the aspect, the first connecting part connects only one end part in the vertical width direction of the horizontal frame part to the outer panel, the second connecting part connects only one end part in the vertical width direction of the first side-direction frame part to the outer panel, and the third connecting part connects only one end part in the vertical width direction of the second side-direction frame part to the outer panel; therefore, the formation number of the connecting parts can be reduced as compared with a structure in which both end parts in the width direction of each of the frame parts are connected to the outer panel, which can reduce the weight and costs.

In this aspect, a connected portion of the first connecting part with respect to the horizonal frame part, a connected portion of the second connecting part with respect to the first side-direction frame part, and a connected portion of the third connecting part with respect to the second side-direction part are aligned at one side in the vertical width direction of respective frame parts. For example, when the first connecting part is connected to one end part on the lower side in the vertical width direction of the horizontal frame part, the connected portions of the second connecting part and the third connecting part with respect to the first side-direction frame part and the second side-direction frame part are respectively connected to one end parts on the lower side in the vertical width direction of respective frame parts. Conversely, when the first connecting part is connected to one end part on the upper side in the vertical width direction of the horizontal frame part, the connected portions of the second connecting part and the third connecting part with respect to the first side-direction frame part and the second side-direction frame part are respectively connected to one end parts on the upper side in the vertical width direction of respective frame parts.

In the case where only one end parts in the vertical width direction of respective frame parts are connected to the outer panel by the first connecting part, the second connecting part, and the third connecting part, torsion may occur at each of the frame parts around an axial center extending in a longitudinal direction due to vibration inputted from the outer panel. In this case, when 3-order resonance of the outer panel is about to occur, behaviors of opposite phases in the front and rear direction may occur at the portion where the first connecting part is connected and the portions where the second connecting part and the third connecting part are respectively connected in the outer panel.

However, in the back door structure of the vehicle according to the above aspect, the first connecting part is connected to the horizontal frame part of the inner panel, the second connecting part is connected to the first side-direction frame part of the inner panel, and the third connecting part is connected to the second side-direction frame part; therefore, torsion of the horizontal frame part due to vibration inputted from the outer panel to the horizontal frame part through the first connecting part is cancelled out by each torsion occurring at the first side-direction frame part and the second side-direction frame part due to vibration inputted from the outer panel to the first side-direction frame part through the second connecting part, and vibration inputted from the outer panel to the second side-direction frame part through the third connecting part.

Accordingly, in the back door structure of the vehicle according to the aspect, the outer panel and the inner panel are connected by three connecting parts while reducing the weight and costs; thereby suppressing vibration of the outer panel during traveling of the vehicle and reducing noise in the vehicle interior.

In the back door structure of the vehicle according to the aspect, the first connection part, the second connecting part, and the third connecting part may be provided so as to overlap one another in side view from the right and left direction.

The first connecting part, the second connecting part, and the third connecting part are provided so as to overlap one another in side view in the back door structure of the vehicle according to the embodiment; therefore, the back door structure of the vehicle has an advantage in suppressing film surface resonance of the outer panel by the inner panel without complicating a resonance mode of the outer panel.

In the back door structure of the vehicle according to the aspect, the second connecting part and the third connecting part may be arranged in a symmetrical positional relationship on the basis of the first connecting part.

In the back door structure of the vehicle according to the aspect, the second connecting part and the third connecting part are formed in the symmetrical positional relationship on the basis of the first connecting part, in other words, the first connecting part is arranged at an approximately middle position between the second connecting part and the third connecting part in the right and left direction (vehicle width direction); therefore, the torsional moment acting on the horizontal frame part by the input from the outer panel through the first connecting part can be effectively cancelled out by the respective torsional moments acting on the first side-direction frame part and the second side-direction frame part by the input from the outer panel in the same manner through each of the second connecting part and the third connecting part.

In the back door structure of the vehicle according to the aspect, the first connecting part may include a connecting wall part connecting between the outer panel and the inner panel in a front and rear direction, and the connecting wall part may have beads formed so as to extend in the front and rear direction.

The back door structure of the vehicle according to the aspect is provided with the beads on the connecting wall part in the first connecting part; therefore, high rigidity of the connecting wall part can be secured with respect to vibration inputted from the outer panel to the inner panel. Accordingly, it is further effective to suppress the film surface resonance of the outer panel by the inner panel.

In the back door structure of the vehicle according to the aspect, the first connecting part may be integrally formed with the horizontal frame part, the second connecting part may be integrally formed with the first side-direction frame part, and the third connecting part may be integrally formed with the second side-direction frame part.

The first connecting part is integrally formed with the horizonal frame part, the second connecting part is integrally formed with the first side-direction frame part, and the third connecting part is integrally formed with the second side-direction frame part, respectively in the back door structure of the vehicle according to the aspect; therefore, the number of parts can be reduced. Furthermore, connection between the first connecting part and the horizontal frame part, connection between the second connecting part and the first side-direction frame part, and connection between the third connecting part and the second side-direction frame part are not necessary, which can reduce man-hours at the time of manufacturing. Accordingly, the back door structure of the vehicle according to the aspect further has an advantage in reducing the weight and costs.

In the back door structure of the vehicle according to the aspect, the inner panel may further include a first vertical frame part, a second vertical frame part, a first merging part, and a second merging part. The first vertical frame part may be a vertical frame part extending between the first opening part and the third opening part in the up and down direction and provided so that an upper end is connected to the lower end of the first side-direction frame part and the right end of the horizontal frame part. The second vertical frame part may be a vertical frame part extending between the first opening part and the fourth opening part in the up and down direction and provided so that an upper end is connected to the lower end of the second side-direction frame part and the left end of the horizontal frame part. The first merging part may be a part provided at a portion where the first vertical frame part, the first side-direction frame part, and the horizontal frame part merge. The second merging part may be a part provided at a portion where the second vertical frame part, the second side-direction frame part, and the horizontal frame part merge.

In this aspect, the first side-direction frame part may be arranged so that an angle made by the first side-direction frame part with an axis line extending along the up and down direction of the back door is larger than an angle made by the first vertical frame part, and the second side-direction frame part may be arranged so that an angle made by the second side-direction frame part with an axis line extending along the up and down direction of the back door is larger than an angle made by the second vertical frame part.

The first side-direction frame part extends outward (to the right side in the right and left direction) as going from the lower side to the upper side at a larger angle than the first vertical frame part, and the second side-direction frame part extends outward (to the left side in the right and left direction) as going from the lower side to the upper side at a larger angle than the second vertical frame part in the back door structure of the vehicle according to the aspect; therefore, a large dimension in the right and left direction (vehicle width direction) can be taken in each of the first merging part and the second merging part as compared with a case where both of the first side-direction frame part and the first vertical frame part are formed along one straight line, and both of the second side-direction frame part and the second vertical frame part are formed along one straight line. Accordingly, cancellation of the torsional moment between the horizontal frame part and the first side-direction frame part through the first merging part, and cancellation of the torsional moment between the horizontal frame part and the second side-direction frame part through the second merging part can be positively executed.

In the back door structure of the vehicle according to the aspect, each of the first merging part and the second merging part may have an approximately triangular shape in front view.

The back door structure of the vehicle according to the aspect has an advantage in dispersing loads inputted from the outer panel to the inner panel through the first connecting part, the second connecting part, and the third connecting part as each of the first merging part and the second merging part has the approximately triangular shape in front view.

Note that the “approximately triangular shape” in the above description means that respective corners have an arc shape or a shape cut in straight lines.

In the back door structure of the vehicle according to the aspect, the first connecting part may connect only one end part on the first opening part's side in the vertical width direction of the horizontal frame part to the outer panel, the second connecting part may connect only one end part on the third opening part's side in the vertical width direction of the first side-direction frame part to the outer panel, and the third connecting part may connect only one end part on the fourth opening part's side in the vertical width direction of the second side-direction frame part to the outer panel.

In the back door structure of the vehicle according to the aspect, the first connecting part is arranged at one end part on the first opening part's side in the vertical width direction of the horizontal frame part, the second connecting part is arranged at one end part on the third opening part's side in the vertical width direction of the first side-direction frame part, and the third connecting part is arranged at one end part on the fourth opening part's side in the vertical width direction of the second side-direction frame part; therefore, an area where a number plate is assumed to be fitted and peripheral areas thereof on the outer panel can be connected to the inner panel by the first connecting part, the second connecting part, and the third connecting part. Accordingly, the area where the number plate is assumed to be fitted in which the film surface resonance tends to occur on the outer panel is connected to the inner panel, thereby further exhibiting an advantage in suppressing the film surface resonance.

The above respective aspects can be combined with each other to the extent possible in the relation between mutual components.

### Advantages

It is possible to reduce noise in the vehicle interior by suppressing vibration of the outer panel while reducing the weight and costs in the back door structure of the vehicle according to the above respective aspects.

### BRIEF DESCRIPTION OF THE DRAWINGS

FIG. 1 is a rear view of a back door according to an embodiment, which is seen from a rear direction of a vehicle.

FIG. 2 is a front view of the back door seen from the front of the vehicle.

FIG. 3 is an enlarged view showing a A-part of FIG. 2 in an enlarged manner.

FIG. 4 is a perspective view showing a structure of a central connecting part.

FIG. 5A is a front view showing a horizontal frame part, side-direction frame parts, and a peripheral structure thereof.

FIG. 5B is a graph showing displacement in 3-order resonance of an outer panel when assuming that the an inner panel is not connected.

### DETAILED DESCRIPTION

Hereinafter, an embodiment of the present disclosure will be explained with reference to the drawings. Note that the description explained below is not at all limited to the following embodiment except its essential structure.

### 1. Entire Structure of Back Door 1

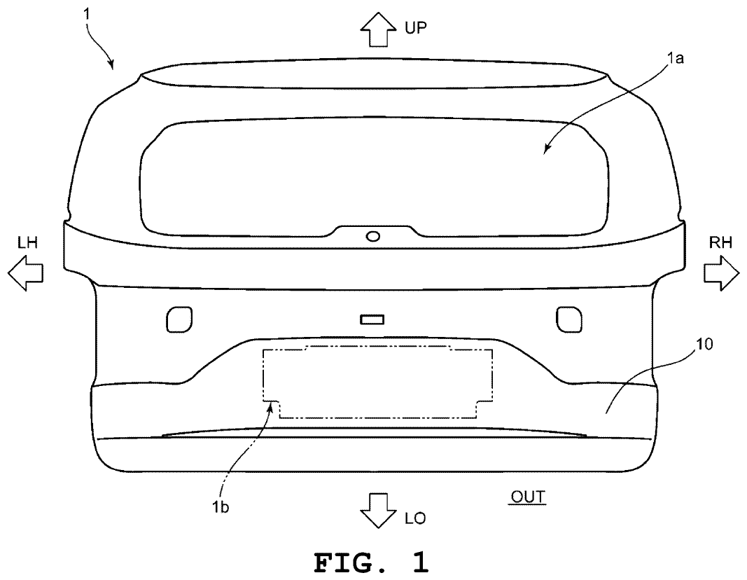

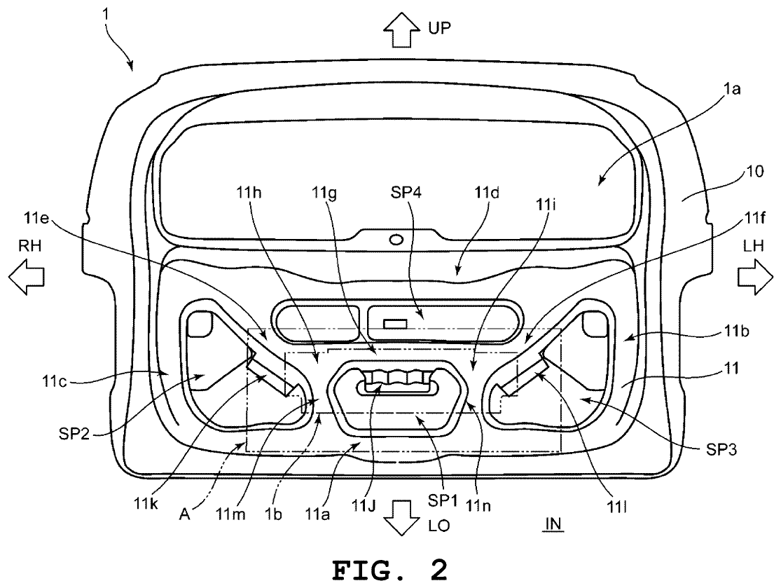

The entire structure of a back door 1 of a vehicle according to the embodiment will be explained with reference to FIG. 1 and FIG. 2. In the specification, directions are indicated on the basis of the vehicle to which the back door 1 is mounted. Specifically, an upper direction of the vehicle is denoted as “UP”, a lower direction of the vehicle is denoted as “LO”, a left direction of the vehicle is denoted as “LH”, and a right direction of the vehicle is denoted as “RH”. The direction of the back door 1 is indicated on the basis of the back door 1 in a state where a rear opening of the vehicle is closed.

As shown in FIG. 1 and FIG. 2, the back door 1 has a windshield opening part 1a to which a windshield is fitted at an upper half part. The back door 1 includes an outer panel 10 and an inner panel 11. The outer panel 10 is a panel forming an outer side of the back door 1. The inner panel 11 is a panel forming an inner side than the outer panel 10 in the back door 1.

An area where a number plate is assumed to be fitted (plate fitting area) 1b is provided at a lower part in a lower half of the back door 1. The plate fitting area 1b is prescribed in consideration of destinations of vehicles to which the back door 1 is applied.

As shown in FIG. 2, four opening parts SP1 to SP4 are provided in the inner panel 11. The opening part (first opening part) SP1 is provided at the central portion in vehicle width direction (right and left direction) of the back door 1 so as to be apart from a lower end side of the inner panel 11. The opening part (second opening part) SP4 is provided between the opening part SP1 and the windshield opening part 1a in an up and down direction of the back door 1 so as to be apart respectively from the opening part SP1 and the windshield opening part 1a. A horizontal width (width in the right and left direction) of the opening part SP4 is set to be wider than the opening part SP1.

The opening part (third opening part) SP2 is provided between the opening part SP1/the opening part SP4 and a right end side of the inner panel 11 so as to be apart respectively from the opening parts SP1, SP4, and the right end side of the inner panel 11. The opening part SP2 has an approximately triangular shape with rounded corners in front view from the front direction of the vehicle. The opening (fourth opening part) SP3 is provided between the opening part SP1/the opening part SP4 and a left end side of the inner panel 11 so as to be apart respectively from the opening parts SP1, SP4, and the left end side of the inner panel 11. The opening part SP3 has an approximately triangular shape with rounded corners that is symmetrical to the opening part SP2 in front view seen from the front direction of the vehicle.

Moreover, as shown in FIG. 2, the inner panel 11 has outer peripheral frame parts 11a to 11d, side-direction frame parts 11e, 11f, vertical frame parts 11m, 11n, and a horizontal frame part 11g. The lower outer peripheral frame part 11a among the outer peripheral frame parts 11a to 11d is a frame part extending between the opening parts SP1/SP2/SP3 and the lower end side of the inner panel 11 in the right and left direction. The side outer peripheral frame part lib is a frame part extending between the opening part SP3 and the left end side of the inner panel 11 in the up and down direction. The lower outer peripheral frame part 11a and the side outer peripheral frame part lib are connected to each other at an abutting portion. The side outer peripheral frame part 11c is a frame part extending between the opening part SP2 and the right end side of the inner panel 11 in the up and down direction. The lower outer peripheral frame part 11a and the side outer peripheral frame part 11c are connected at an abutting portion therebetween. The upper outer peripheral frame part 11d is a frame part extending between the opening parts SP4/SP2/SP3 and the windshield opening part 1a in the right and left direction. The side outer peripheral frame part 11b, the side outer peripheral frame part 11c, and the upper outer peripheral frame part 11d are connected at abutting portions therebetween.

The side-direction frame part (first side-direction frame part) 11e is a frame part extending between the opening part SP4 and the opening part SP2 in the up and down direction. The side-direction frame part 11e is provided to be inclined so as to gradually come close to the side outer peripheral frame part 11c side (side of the right end side of the inner panel 11) as going from a lower end to an upper end. The side-direction frame part 11e is connected to the side outer peripheral frame part 11c and the upper outer peripheral frame part 11d at the upper end.

The side-direction frame part (second side-direction frame part) 11f is a frame part extending between the opening part SP4 and the opening part SP3 in the up and down direction. The side-direction frame part 11f is provided to be inclined so as to gradually come close to the side outer peripheral frame part lib side (side of the left end side of the inner panel 11) as going from a lower end to an upper end. The side-direction frame part 11f is connected to the side outer peripheral frame part 11b and the upper outer peripheral frame part 11d at the upper end.

The horizontal frame part 11g is a frame part extending between the opening part SP1 and the opening part SP4 in the right and left direction. The horizontal frame part 11g is connected to the lower end of the side-direction frame part 11e at a right end and is connected to the lower end of the side-direction frame part 11f at a left end.

Here, the horizontal frame part 11g is connected to the side-direction frame part 11e at the right end and connected to the side-direction frame part 11f at the left end as described above. Therefore, when these frame parts 11e to 11g are seen as a whole, these parts can be regarded as one frame part extending in the right and left direction.

The vertical frame part (first vertical frame part) 11m is a frame part extending in the up and down direction between the opening part SP1 and the opening part SP2. The vertical frame part 11m is connected to the lower outer peripheral frame part 11a at a lower end and is connected to the lower end of the side-direction frame part 11e and the right end of the horizontal frame part 11g at an upper end. The vertical frame part (second frame part) 11n is a frame part extending in the up and down direction between the opening part SP1 and the opening part SP3. The vertical frame part 11n is connected to the lower outer peripheral frame part 11a at a lower end and is connected to the lower end of the side-direction frame part 11f and the right end of the horizontal frame part 11g at an upper end.

In the inner panel 11, a portion where the side-direction frame part 11e, the horizontal frame part 11g, and the vertical frame part 11m are connected (portion where these parts merge) is defined as a merging part (first merging part) 11h, and a portion where the side-direction frame part 11f, the horizontal frame part 11g, and the vertical frame part 11n are connected (portion where these parts merge) is defined as a merging part (second merging part) 11i. Note that the merging part 11h and the merging part 11i are formed in symmetrical shapes in the embodiment.

As shown in FIG. 2, the inner panel 11 further includes three connecting parts 11j to 11l. The central connecting part (first connecting part) 11j among the three connecting parts 11j to 11l is integrally formed with the horizontal frame part 11g. The side connecting part (second connecting part) 11k is integrally formed with the side-direction frame part 11e. The side connecting part (third connecting part) 11l is integrally formed with the side-direction frame part 11f.

The central connecting part 11j connects the horizontal frame part 11g and the outer panel 10 at a central portion in the right and left direction of the back door 1. The side connecting part 11k connects the side-direction frame part 11e and the outer panel 10 at a right portion of the back door. The side connecting part 11l connects the side-direction frame part 11f and the outer panel 10 at a left portion of the back door 1.

### 2. Detailed Structure of Merging Parts 11h, 11i in Inner Panel 11 and Peripheral Area Thereof

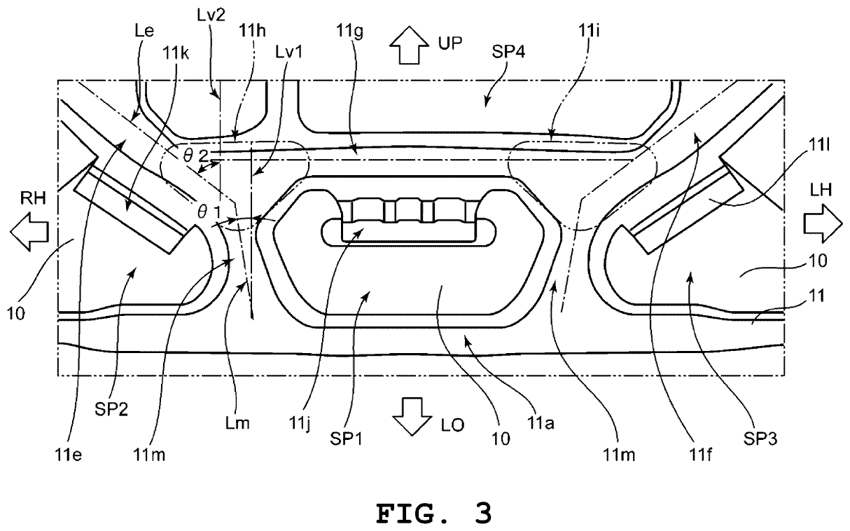

The detailed structure of the merging parts 11h, 11i in the inner panel 11 and a peripheral area thereof will be explained with reference to FIG. 3.

As shown in FIG. 3, the merging part 11h is provided at an area surrounded by the opening part SP1, the opening part SP2, and the opening part SP4, and the merging part 11i is provided at an area surrounded by the opening part SP1, the opening part SP3, and the opening part SP4. Accordingly, each of the merging parts 11h, 11i has an approximately triangular shape in which a width in the right and left direction gradually increases as going from the lower part to the upper part. Although each of the merging parts 11h, iii is shown as the triangular shape with rounded corners in FIG. 3, it is possible to prescribe each merging part as a triangular shape (precisely, a hexagonal shape) with respective corners cut in straight lines.

In the back door 1 according to the embodiment, the side-direction frame part 11e and the vertical frame part 11m are provided so that extending angles thereof differ from each other. Specifically, when a center line of the vertical frame part 11m is Lm, and a center line of the side-direction frame part 11e is Le, angles θ1, θ2 made by the center lines and reference lines Lv1, Lv2 extending along the up and down direction of the back door 1 are set so as to satisfy the following relation.

θ2>θ1 (formula 1)

The side-direction frame part 11f and the vertical frame part 11n on the left side are also provided so that these angles differ from each other.

In the back door 1 according to the embodiment, each of the side-direction frame parts 11e, 11f is formed so as to have a larger inclination angle than each of the vertical frame parts 11m 11n in the inner panel 11.

The side-direction frame part 11e and the side-direction frame part 11f are formed in a symmetrical relationship, and the vertical frame part 11m and the vertical frame part 11n are also formed in the symmetrical relationship.

### 3. Detailed Structure of Connecting Parts 11j to 11l

The detailed structure of the connecting parts 11j to 11l in the inner panel 11 will be explained with reference to FIG. 3.

As shown in FIG. 3, the central connecting part 11j is extended only from one end part on the opening part SP1 side in a vertical width direction of the horizontal frame part 11g, extending toward the outer panel 10 arranged on the rear side of the vehicle (toward the back side of the paper in FIG. 3) and being connected to the outer panel 10 at the end part. The side connecting part 11k is extended only from one end part on the opening part SP2 side in the vertical width direction of the side-direction frame part 11e, extending toward the outer panel 10 arranged on the rear side of the vehicle (toward the back side of the paper in FIG. 3) and being connected to the outer panel 10 at the end part. The side connecting part 11l is extended only from one end part on the opening part SP3 side in the vertical width direction of the side-direction frame part 11f, extending toward the outer panel 10 arranged on the rear side of the vehicle (toward the back side of the paper in FIG. 3) and being connected to the outer panel 10 at the end part.

The side connecting part 11k and the side connecting part 11l are arranged at symmetrical positions on the basis of the central connecting part 11j in the right and left direction. In other words, the central connecting part 11j is arranged at the middle position between the side connecting part 11k and the side connecting part 11l in the right and left direction.

When the central connecting part 11j and the side connecting parts 11k, 11l are seen from the side in the right and left direction, the connecting parts 11j to 11l are arranged in a positional relationship of overlapping one another. The connecting parts 11j to 11l are arranged in an area containing the plate fitting area 1b in the up and down direction.

Note that an extending portion of the central connecting part 11j with respect to the horizontal frame part 11g, an extending portion of the side connecting part 11k with respect to the side-direction frame part 11e, and an extending portion of the side connecting part 11l with respect to the side-direction frame part 11f are aligned at one end parts in the vertical width direction of respective frame parts 11e to 11g. That is, one end part on the lower side in the vertical width direction of the horizontal frame part 11g is connected to the outer panel 10 by the central connecting part 11j, one end part on the lower side in the vertical width direction of the side-direction frame part 11e is connected to the outer panel 10 by the side connecting part 11k, and one end part on the lower side in the vertical width direction of the side-direction frame part 11f is connected to the outer panel 10 by the side connecting part 11l in the embodiment.

### 4. Structure of Central Connecting Part 11j

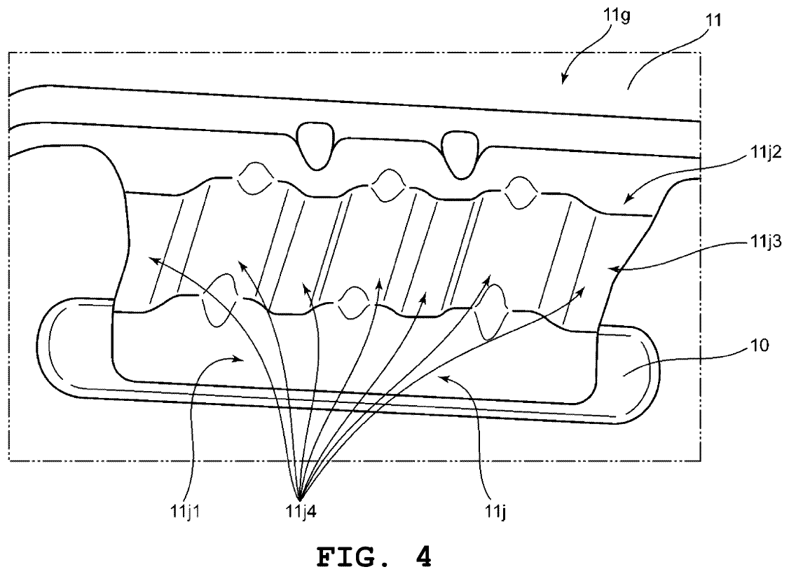

The structure of the central connection part 11j extended from one end part in the width direction of the horizontal frame part 11g will be explained with reference to FIG. 4.

As shown in FIG. 4, an outer joining part llj1, an inner bending part 11j2, and a standing wall part (connecting wall part) 11j3 are continuously formed in the central connecting part 11j. The outer joining part llj1 is a part joined to the outer panel 10. Joining between the outer joining part llj1 and the outer panel 10 is made, for example, by spot welding or by using an adhesive.

The inner bending part 11j2 is a part having an L-shape in cross section extending from one end part in the width direction of the horizontal frame part 11g and bent toward the outer panel 10. The standing wall part 11j3 is a wall part connecting between the outer joining part llj1 and the inner bending part 11j2, which is formed so as to extend in a front and rear direction of the vehicle and in the vehicle width direction.

As shown in FIG. 4, a plurality of beads 11j4 are formed on the standing wall part j3 of the central connecting part 11j. The plurality of beads 11j4 are formed so as to respectively extend in the front and rear direction and so as to be aligned in the right and left direction (vehicle width direction).

Suppression of Film Surface Resonance of Outer Panel 10 in Back Door 1

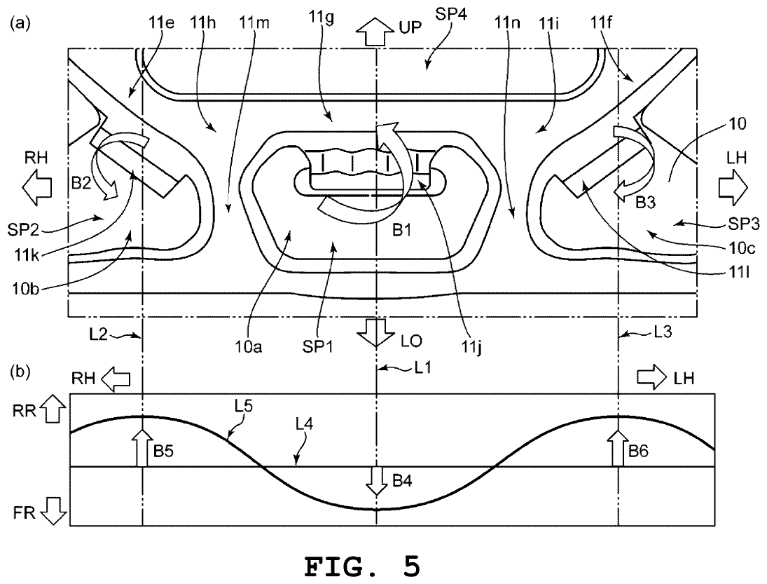

A mechanism for suppressing the film surface resonance of the outer panel 10 in the back door 1 according to the embodiment will be explained with reference to FIGS. 5A and 5B. FIG. 5B is a graph for showing displacement in the film surface resonance (3-order resonance) of the outer panel 10 occurring during traveling of the vehicle when assuming that the frame parts 11e to 11g in the inner panel 11 are not connected to the outer panel 10.

As shown in FIG. 5A, a width-direction central portion 10a where the central connecting part 11j is connected may be displaced so as to float to the front side, and respective width-direction side portions 10b, 10c where the side connecting parts 11k, 11l are connected may be displaced to the rear side in the outer panel 10 during traveling of the vehicle. That is, when assuming that the frame parts 11e to 11g of the inner panel 11 are not connected to the outer panel 10, a line L5 in which an area containing a portion indicated by a virtual line L1 is displaced to the front side as shown by an arrow B4 and areas containing portions indicated by virtual lines L2, L3 are displaced to the rear side as shown by arrows B5, B6 is made with respect to a line L4 of the outer panel 10 before displacement as shown in FIG. 5B.

Even when the 3-order resonance of the outer panel 10 is about to occur during traveling of the vehicle, the frame parts 11e to 11g of the inner panel 11 are connected to the outer panel 10 through the three connecting parts 11j to 11l in the back door 1 according to the embodiment; therefore, the 3-order resonance of the outer panel 10 is suppressed. Specifically, when the outer panel 10 is about to vibrate as described above, the torsional moment indicated by an arrow B1 acts on the horizontal frame part 11g by the input through the central connecting part 11j, the torsional moment indicated by an arrow B2 acts on the side-direction frame part 11e by the input through the side connecting part 11k, and the torsional moment indicated by an arrow B3 acts on the side-direction frame part 11f by the input through the side connecting part 11l. Since each of the side-direction frame parts 11e, 11f and the horizontal frame part 11g are formed so as to be connected at the merging parts 11h, 11i, the torsional moment indicated by the arrow B1 is cancelled out by the torsional moments indicated by the arrows B2, B3.

The horizontal frame part 11g is connected to the side-direction frame part 11e at the right end, and is connected to the side-direction frame part 11f at the left end as described above. Accordingly, when these frame parts 11e to 11g are seen as a whole, these parts can be regarded as one frame part extending in the right and left direction. The extending portion of the central connecting part 11j with respect to the horizontal frame part 11g, the extending portion of the side connecting part 11k with respect to the side-direction frame part 11e, and the extending portion of the side connecting part 11l with respect to the side-direction frame part 11f are aligned on one side in the vertical width direction of respective frame parts 11e to 11g in the embodiment.

Therefore, the film surface resonance of the outer panel 10 during traveling of the vehicle can be suppressed in the back door 1 according to the embodiment.

### 6. Advantages

In the back door 1 of the vehicle according to the embodiment, the central connecting part 11j connects only one end part in the vertical width direction of the horizontal frame part 11g and the outer panel 10, the side connecting part 11k connects only one end part in the vertical width direction of the side-direction frame part 11e and the outer panel 10, and the side connecting part 11l connects only one end part in the vertical width direction of the side-direction frame part 11f and the outer panel 10; therefore, the formation number of the connecting parts 11j to 11l can be reduced as compared with a structure in which both end parts in the vertical width direction of each of the frame parts 11e to 11g are connected to the outer panel 10, which can reduce the weight and costs.

When only one end part in the vertical width direction of each of the frame parts 11e to 11g is connected to the outer panel 10 by the connecting parts 11j to 11l as in the embodiment, torsion may occur (the torsional moment occurs) in the respective frame parts 11e to 11g around axial centers extending in the longitudinal direction due to vibration inputted from the outer panel 10. In this case, when the 3-order resonance is about to occur, behaviors of opposite phases in the front and rear direction may occur at the portion where the central connecting part 11j is connected (the horizontal frame part 11g) and the portions where the side connecting parts 11k, 11l are respectively connected (the side-direction frame parts 11e, 11f) in the outer panel 10.

However, the central connecting part 11j is connected to the horizontal frame part 11g of the inner panel 11, the side connecting part 11k is connected to the side-direction frame part 11e of the inner panel 11, and the side connecting part 11l is connected to the side-direction frame part 11f in the back door 1; therefore, the torsional moment of the horizontal frame part 11g due to vibration inputted from the outer panel 10 to the horizontal frame part 11g through the central connecting part 11j is cancelled out by the torsional moments occurring at the side-direction frame parts 11e, 11f due to vibration inputted from the outer panel 10 to the side-direction frame part 11e through the side connecting part 11k, and vibration inputted from the outer panel 10 to the side-direction frame part 11f through the side connecting part 11l.

Accordingly, the outer panel 10 and the inner panel 11 are connected by the three connecting parts 11k to 11l while reducing the weight and costs, thereby suppressing vibration at the outer panel 10 during traveling of the vehicle and reducing noise in the vehicle interior in the back door 1 of the vehicle according to the embodiment.

Moreover, the central connecting part 11j and the side connecting parts 11k, 11l are provided so as to overlap one another in side view from the right and left direction in the back door 1 of the vehicle according to the embodiment; therefore, the back door 1 of the vehicle has an advantage in suppressing the film surface resonance of the outer panel 10 by the inner panel 11 without complicating a resonance mode of the outer panel 10.

In the back door 1 of the vehicle according to the embodiment, the side connecting part 11k and the side connecting part 11l are formed in the symmetrical positional relationship on the basis of the central connecting part 11j, in other words, the central connecting part 11j is arranged at an approximately middle position between the side connecting part 11k and the side connecting part 11l in the right and left direction (vehicle width direction); therefore, the torsional moment acting on the horizontal frame part by the input from the outer panel 10 through the central connecting part 11j can be effectively cancelled out by respective torsional moments acting on the side-direction frame parts 11e, 11f by the input from the outer panel in the same manner through the respective side connecting parts 11k, 11l.

Moreover, the back door 1 of the vehicle according to the embodiment is provided with the beads 11j4 on the standing wall part 11j3 in the central connecting part 11j; therefore, high rigidity of the standing wall part 11j3 can be secured with respect to vibration inputted from the outer panel 10 to the inner panel 11. Accordingly, it is further effective to suppress the film surface resonance of the outer panel 10 by the inner panel 11.

Moreover, the central connecting part 11j is integrally formed with the horizonal frame part 11g, the side connecting part 11k is integrally formed with the side-direction frame part 11e, and the side connecting part 11l is integrally formed with the side-direction frame part 11f, respectively in the back door 1 of the vehicle according to the embodiment; therefore, the number of parts can be reduced. Furthermore, connection between the central connecting part 11j and the horizontal frame part 11g, connection between the side connecting part 11k and the side-direction frame part 11e, and connection between the side connecting part 11l and the side-direction frame part 11f are not necessary, which can reduce man-hours at the time of manufacturing. Accordingly, the back door 1 of the vehicle according to the embodiment further has an advantage in reducing the weight and costs.

Moreover, the side-direction frame part 11e extends outward (to the right side in the right and left direction) as going from the lower side to the upper side at a larger angle than the vertical frame part 11m, and the side-direction frame part 11f extends outward (to the left side in the right and left direction) as going from the lower side to the upper side at a larger angle than the vertical frame part 11n in the back door 1 of the vehicle according to the embodiment; therefore, a large dimension in the right and left direction (vehicle width direction) can be taken in each of the merging parts 11h, 11i as compared with a case where both of the side-direction frame part 11e and the vertical frame part 11m are formed along one straight line and both of the side-direction frame part 11f and the vertical frame part 11n are formed along one straight line. Accordingly, cancellation of the torsional moment between the horizontal frame part 11g and the side-direction frame part 11e through the merging part 11h, and cancellation of the torsional moment between the horizontal frame part 11g and the side-direction frame part 11f through the merging part iii can be positively executed in the back door 1.

Moreover, the back door 1 of the vehicle according to the embodiment has an advantage in dispersing loads inputted from the outer panel 10 to the inner panel 11 through the respective connecting parts 11j to 11l as each of the merging parts 11h, iii has the approximately triangular shape in front view.

Furthermore, in the back door 1 of the vehicle according to the embodiment, the central connecting part 11j is arranged at one end part on the opening part SP1 side in the vertical width direction of the horizontal frame part 11g, the side connecting part 11k is arranged at one end part on the opening part SP2 side in the vertical width direction of the side-direction frame part 11e, and the side connecting part 11l is arranged at one end part on the opening part SP3 side in the vertical width direction of the side-direction frame part 11f; therefore, the plate fitting area 1b and peripheral areas thereof on the outer panel 10 can be connected to the inner panel 11 by the connecting parts 11j to 11l. Accordingly, the plate fitting area 1b where the film surface resonance tends to occur on the outer panel 10 is connected to the inner panel 11, thereby further exhibiting an advantage in suppressing the film surface resonance.

As described above, it is possible to reduce noise in the vehicle interior by suppressing vibration of the outer panel 10 while reducing the weight and costs in the back door 1 of the vehicle according to the embodiment.

### Modification Examples

The three connecting parts 11j to 11l are arranged so as to overlap one another when the three connecting parts 11j to 11l are seen from the side in the right and left direction in the above embodiment; however, it is not always necessary that the three connecting parts overlap one another in the present disclosure.

The structure in which the side connecting part 11k and the side connecting part 11l are arranged at symmetrical positions in front view from the front and rear direction, and the central connecting part 11j is arranged at a middle portion between the side connecting parts 11k, 11l is adopted in the above embodiment; however, it is not always necessary that the side connecting parts are arranged in the symmetrical positional relationship and it is not always necessary that the central connecting part is arranged at the middle portion between the side connecting parts in the present disclosure.

The structure in which the beads 11j4 are formed on the standing wall part 11j3 of the central connecting part 11j is adopted in the above embodiment; however, a structure in which beads are formed on standing wall parts (connecting wall parts) of all connecting parts can be adopted and a structure in which any bead is not formed on each of standing wall parts of all connecting parts can be also adopted.

The structure in which the connecting part 11j to 11l are integrally formed with the frame parts 11e to 11g of the inner panel 11 is adopted in the above embodiment; however, it is possible to adopt a structure in which connecting parts are separated from the inner panel in the present disclosure.

Moreover, the structure in which the central connecting part 11j extends to the opening part SP1 side, the side connecting part 11k extends to the opening part SP2 side, and the side connecting part 11l extends to the opening part SP3 side is adopted in the above embodiment; however, the present disclosure is not limited to this. For example, a structure in which the central connecting part and the side connecting parts respectively extend to the opening part SP4 side can be adopted.

The structure in which extending angles of the side-direction frame part 11e and the vertical frame part 11m differ from each other and extending angles of the side-direction frame part 11f and the vertical frame part 11n differ from each other is adopted in the above embodiment; however, it is possible to adopt a structure in which the side-direction frame part and the vertical frame part are placed on one straight line in the present disclosure.

The structure in which the inner panel 11 includes the outer peripheral frame parts 11a to 11d is adopted in the above embodiment; however, it is not always necessary that the inner panel includes the outer peripheral frame parts.

Moreover, the structure in which one end part on the lower side in the vertical width direction of the horizontal frame part 11g and the outer panel 10 are connected by the central connecting part 11j, one end part on the lower side in the vertical width direction of the side-direction frame part 11e and the outer panel 10 are connected by the side connecting part 11k, and one end part on the lower side in the vertical width direction of the side-direction frame part 11f and the outer panel 10 are connected by the side connecting part 11l is adopted in the above embodiment; however, the present disclosure is not limited to this. For example, a structure in which one end part on the upper side in the vertical width direction of the horizontal frame part and the outer panel are connected by the central connecting part, and one end parts on the upper side in the vertical width direction of respective side-direction frame parts and the outer panel are connected by right-and-left both sides of side connecting parts can be adopted. The same advantages as the above embodiment can be obtained also in the case where respective connecting parts are arranged in this manner.

1. A back door structure of a vehicle that includes a windshield opening part to which a windshield is fitted, comprising:
an outer panel forming an outer side of the vehicle in the back door;
an inner panel forming an inner side of the vehicle in the back door; and
a plurality of connecting parts connecting the outer panel and the inner panel,
wherein the inner panel includes a first opening part provided above a lower end side of the inner panel in a lower portion than the windshield opening part, a second opening part provided between the first opening part and the windshield opening part, a third opening part provided between the first and second opening part and a right end side of the inner panel, a fourth opening part provided between the first and second opening part and a left end side of the inner panel, a first side-direction frame part extending between the second opening part and the third opening part in an up and down direction and provided to be inclined so as to approach the side of the right end side as going from a lower end to an upper end, a second side-direction frame part extending between the second opening part and the fourth opening part in the up and down direction and provided to be inclined so as to approach the side of the left end side as going from a lower end to an upper end, and a horizontal frame part extending between the first opening part and the second opening part in a right and left direction and provided so that a right end is connected to the lower end of the first side-direction frame part and a left end is connected to the lower end of the second side-direction frame part, and
the plurality of connecting part includes a first connecting part connecting only one end part in a vertical width direction of the horizontal frame part to the outer panel, a second connecting part connecting only one end part in the vertical width direction of the first side-direction frame part to the outer panel, and a third connecting part connecting only one end part in the vertical width direction of the second side-direction frame part to the outer panel.

2. The back door structure of the vehicle according to claim 1,
wherein the first connecting part, the second connecting part, and the third connecting part are provided so as to overlap one another in side view from the right and left direction.

3. The back door structure of the vehicle according to claim 2,
wherein the second connecting part and the third connecting part are arranged in a symmetrical positional relationship based on the first connecting part.

4. The back door structure of the vehicle according to claim 2,
wherein the first connecting part includes a connecting wall part connecting between the outer panel and the inner panel in a front and rear direction, and
the connecting wall part has beads formed so as to extend in the front and rear direction.

5. The back door structure of the vehicle according to claim 2,
wherein the first connecting part is integrally formed with the horizontal frame part,
the second connecting part is integrally formed with the first side-direction frame part, and
the third connecting part is integrally formed with the second side-direction frame part.

6. The back door structure of the vehicle according to claim 2,
wherein the inner panel further includes a first vertical frame part extending between the first opening part and the third opening part in the up and down direction and provided so that an upper end is connected to the lower end of the first side-direction frame part and the right end of the horizontal frame part, a second vertical frame part extending between the first opening part and the fourth opening part in the up and down direction and provided so that an upper end is connected to the lower end of the second side-direction frame part and the left end of the horizontal frame part, a first merging part provided at a portion where the first vertical frame part, the first side-direction frame part, and the horizontal frame part merge, and a second merging part provided at a portion where the second vertical frame part, the second side-direction frame part, and the horizontal frame part merge,
wherein the first side-direction frame part is arranged so that an angle made by the first side-direction frame part with an axis line extending along the up and down direction of the back door is larger than an angle made by the first vertical frame part, and
wherein the second side-direction frame part is arranged so that an angle made by the second side-direction frame part with an axis line extending along the up and down direction of the back door is larger than an angle made by the second vertical frame part.

7. The back door structure of the vehicle according to claim 6,
wherein each of the first merging part and the second merging part has an approximately triangular shape in front view.

8. The back door structure of the vehicle according to claim 2,
wherein the first connecting part connects only one end part on the first opening part's side in the vertical width direction of the horizontal frame part to the outer panel,
the second connecting part connects only one end part on the third opening part's side in the vertical width direction of the first side-direction frame part to the outer panel, and
the third connecting part connects only one end part on the fourth opening part's side in the vertical width direction of the second side-direction frame part to the outer panel.

9. The back door structure of the vehicle according to claim 1,
wherein the second connecting part and the third connecting part are arranged in a symmetrical positional relationship based on the first connecting part.

10. The back door structure of the vehicle according to claim 1,
wherein the first connecting part includes a connecting wall part connecting between the outer panel and the inner panel in a front and rear direction, and
the connecting wall part has beads formed so as to extend in the front and rear direction.

11. The back door structure of the vehicle according to claim 1,
wherein the first connecting part is integrally formed with the horizontal frame part,
the second connecting part is integrally formed with the first side-direction frame part, and
the third connecting part is integrally formed with the second side-direction frame part.

12. The back door structure of the vehicle according to claim 1,
wherein the inner panel further includes a first vertical frame part extending between the first opening part and the third opening part in the up and down direction and provided so that an upper end is connected to the lower end of the first side-direction frame part and the right end of the horizontal frame part, a second vertical frame part extending between the first opening part and the fourth opening part in the up and down direction and provided so that an upper end is connected to the lower end of the second side-direction frame part and the left end of the horizontal frame part, a first merging part provided at a portion where the first vertical frame part, the first side-direction frame part, and the horizontal frame part merge, and a second merging part provided at a portion where the second vertical frame part, the second side-direction frame part, and the horizontal frame part merge,
wherein the first side-direction frame part is arranged so that an angle made by the first side-direction frame part with an axis line extending along the up and down direction of the back door is larger than an angle made by the first vertical frame part, and
wherein the second side-direction frame part is arranged so that an angle made by the second side-direction frame part with an axis line extending along the up and down direction of the back door is larger than an angle made by the second vertical frame part.

13. The back door structure of the vehicle according to claim 12,
wherein each of the first merging part and the second merging part has an approximately triangular shape in front view.

14. The back door structure of the vehicle according to claim 1,
wherein the first connecting part connects only one end part on the first opening part's side in the vertical width direction of the horizontal frame part to the outer panel,
the second connecting part connects only one end part on the third opening part's side in the vertical width direction of the first side-direction frame part to the outer panel, and
the third connecting part connects only one end part on the fourth opening part's side in the vertical width direction of the second side-direction frame part to the outer panel.
